(19) United States
(12) Patent Application Publication
(10) Pub. No.: US 2015/0330495 A1
(43) Pub. Date: Nov. 19, 2015

(54) Gear Wheel and Transmission Comprising Such a Gear Wheel

(71) Applicant: LENZE DRIVES GMBH, Extertal (DE)

(72) Inventors: Tino GOETZ, Wennigsens (DE); Ralf-Torsten GUHL, Aerzen (DE)

(21) Appl. No.: 14/653,060

(22) PCT Filed: Dec. 18, 2013
(86) PCT No.: PCT/EP2013/077182

§ 371 Date: Jun. 17, 2015

(30) Foreign Application Priority Data
Dec. 18, 2012 (DE) 10 2012 223 654.6

(51) Int. Cl. F16H 55/08; F16H 1/34; F16H 1/24

(52) U.S. Cl. CPC F16H 55/08; F16H 1/24; F16H 1/34

(57) ABSTRACT

A gear wheel includes precisely two teeth. The gear wheel is mounted rotatably about a gear wheel axis and wherein, in a sectional plane arranged orthogonally to the gear wheel axis, the gear wheel has a cross-sectional surface, which is intersected in its geometric center by the gear wheel axis (12), which has in the region of both teeth (10a, 10b) its maximum extension (dmax) through the geometric center and which, offset in the circumferential direction with respect to the direction of maximum extension, has its minimum extension (dmin). The outer contour of the cross-sectional surface is formed convexly over the entire circumference.

### FIELD OF THE INVENTION

The invention relates to a gear wheel with precisely two teeth as well as a gear wheel pairing with such a gear wheel and a transmission with such a gear wheel pairing.

### BACKGROUND AND SUMMARY OF THE INVENTION

Gear wheels formed as spur wheels are generally known as core components of gear wheel transmissions. In order to achieve a high transmission ratio, it is necessary to select the ratio between the number of teeth of two gear wheels which cog with one another to be as large as possible. In order not to allow the absolute number of respective teeth to be too high, it is expedient to configure the gear wheel with the lower number of teeth with as small as possible a number of teeth.

Gear wheels with only two teeth are known from the prior art. Such a gear wheel is apparent, for example, from DE 2006 011 877 U1. The gear wheel proposed there is configured in the manner of an involute-toothed gear wheel which means in the case of a gear wheel with only two teeth that concave indentations are respectively provided between the teeth. This configuration of the gear wheel leads, however, to insufficient strength in the region of the concave indentations depending on the application.

EP 2 177 788 A1 discloses in the context of a gear wheel pairing a smaller gear wheel which has a cross-sectional surface which has a circular circumference and is arranged eccentrically relative to the axis of the smaller wheel. This wheel has the disadvantage of an unbalanced mass as a result of the eccentric configuration which leads to a higher bearing load.

The object of the invention is to configure a gear wheel with two teeth such that this avoids the disadvantages of the prior art.

According to the invention, this is achieved by a gear wheel with precisely two teeth which is rotatable about a gear wheel axis, wherein in a sectional plane, which is arranged orthogonally to the gear wheel axis, the gear wheel has a cross-sectional surface which is intersected in its geometric center by the gear wheel axis which has in the region of its two teeth its maximum extension through the geometric center and which, offset in the circumferential direction with respect to the direction of maximum extension, has its minimum extension, and the outer contour of which is formed convexly over the entire circumference.

In the simplest configuration, a gear wheel according to the invention thus has the form of a cylinder with elliptical cross-sectional surface. In a further configuration, the gear wheel has the form of a cone with elliptical cross-sectional surface. It is significant that the cross-sectional surface of the gear wheel is intersected in the region of the center by the gear wheel axis, wherein the gear wheel can be provided in the stated region for positive-locking or non-positive-locking coupling to a gear wheel shaft for this purpose. Such a gear wheel shaft can, where necessary, also be formed in one piece with the gear wheel. The gear wheel according to the invention is free of imbalance as a result of the stated arrangement of the gear wheel shaft.

The stated cylindrical configuration involves a straight toothing. Such a straight toothing can be used where the gear wheel is in engagement with more than one drive gear wheel, as is, for example, the case with the planetary wheels of a planetary transmission. A straight toothing is likewise possible in the case of a conical configuration. Such a toothing can be used, for example, in a bevel wheel transmission. However, a configuration is preferred in which the gear wheel is helically geared, wherein an overlap angle of each of the two teeth is at least 180°. In the case of such a helical gearing, the two teeth of the gear wheel according to the invention thus run along a helical track at least by 180° on the outer side of the gear wheel in order to remain permanently in engagement with said gear wheel during cogging with a gear wheel which is likewise helically geared.

The helical angle, i.e. the angle which is provided between the gear wheel axis and the helical extension of each of the two teeth, is preferably between 0° and 65° and in particular preferably between 15° and 50°. A small value is desired in the case of the helical angle in order to keep the axial force component which acts on the gear wheel according to the invention with two teeth low. An axial force component can also be prevented in the case of larger helical angles by a herringbone gearing.

The maximum extension of the cross-sectional surface is provided in the region of the two teeth, which is to be understood such that an imaginary connecting line between the two opposite teeth is aligned in the direction of the maximum extension of the cross-sectional surface. The direction in which the cross-sectional surface is minimally extended is preferably at a 90° angle thereto, wherein this is not absolutely essential. A high stability of the gear wheel is achieved by a comparatively small factor between minimum and maximum extension, as a result of which stability tooth breaking and other wear can be kept low. In order to achieve as large as possible a contact area between the gear wheel according to the invention with two teeth, on one hand, and a second gear wheel, which drives the latter or is driven by the latter, a comparatively large factor between maximum and minimum extension is, however, expedient. In the consideration, it has been shown to be advantageous if the factor is between 1.25 and 2.25. A particularly advantageous configuration is provided if the maximum extension of the cross-sectional surface of the gear wheel is approximately or precisely double the minimum extension so that the factor is 2 (+/−10%).

The cross-sectional surface of the gear wheel preferably has a shape in which there is point symmetry relative to the gear wheel axis, in particular a line symmetry relative to two axes of symmetry orthogonal to one another. A cross-sectional surface, the outer contours of which describe the form of an ellipse, is particularly advantageous. The outer contour can thus be described via the formula:

x²/a²+y²/b²=1

wherein the maximum extension of the cross-sectional surface is 2×a and wherein the minimum extension of the cross-sectional surface is 2×b.

A configuration of the cross-sectional surface with an outer contour which corresponds to a superellipse is also possible in the case of identical axes of symmetry. This outer contour can then be described with the formula

|x/a|n+|y/b|n=1

In the case of a helically geared gear wheel, an overlap angle of at least 180° for each tooth is to be selected in the manner already stated above, so that both teeth jointly enable a permanent engagement with a second gear wheel. It is particularly advantageous if the overlap is less than 360° since as a result of this a compact design of the gear wheel according to the invention is possible.

The invention relates, in addition to the gear wheel with two teeth, itself also to a gear wheel arrangement with at least two gear wheels located in cogging engagement, wherein the smaller of the two gear wheels or the smallest of more than two gear wheels is formed in the manner described above with only two teeth. The stated gear wheel arrangement has the property that the transmission ratio of a respective gear wheel pairing is/can be independent of the rotational angle, i.e. is/can be constant across the rotation of the gear wheels. It is furthermore not absolutely essential that the larger gear wheel(s) has/have an elliptical cross-section or a convex outer contour.

The other gear wheel(s) preferably have a number of teeth of ten or more teeth so that at least a transmission ratio of 5 can be realized as a result of this.

Since it has already been described above that a helical gearing can be omitted if the gear wheel according to the invention cogs with more than two drive wheels, it is regarded as advantageous if such an arrangement is provided in which at least two larger gear wheels cog simultaneously with the small gear wheel according to the invention. Such a constellation is possible, for example, in the case of a planetary transmission.

In order to enable lightweight and efficient gear wheel arrangements, one configuration has been shown to be particularly advantageous in which the smaller or the smallest of the gear wheels is manufactured from metal, while the larger gear wheels which cog therewith are manufactured from plastic. Since the loading of the individual teeth on the small gear wheel is significantly higher, the metallic configuration here is advantageous for high running times. In the case of the larger gear wheels, as a result of the lower loading of the individual tooth, such a material selection is not necessary so that lower cost plastic can be used. In the case of transmissions in which up to 2 kW of mechanical power is transmitted, such a pairing of plastic and metal is advantageous.

The invention furthermore also relates to a transmission with a gear wheel arrangement of the described type. This can involve in particular a planetary transmission, the sun wheel of which is formed by the gear wheel with two teeth. It can furthermore involve a bevel wheel transmission, the bevel pinion of which is formed by the gear wheel with two teeth.

### BRIEF DESCRIPTION OF THE DRAWINGS

Further aspects and advantages of the invention will become apparent both from the claims and from the following description of two preferred exemplary embodiments of the invention which is explained on the basis of the figures. In the figures:

FIG. 1 shows a gear wheel arrangement with a gear wheel according to the invention with two teeth and a second gear wheel which drives this gear wheel with two teeth;

FIG. 2 shows a gear wheel arrangement with a gear wheel according to the invention with two teeth and a second gear wheel which drives this gear wheel with two teeth; and

FIG. 3 shows a second gear wheel arrangement which can be found in the represented form in a planetary transmission.

### DETAILED DESCRIPTION OF THE EXEMPLARY EMBODIMENT

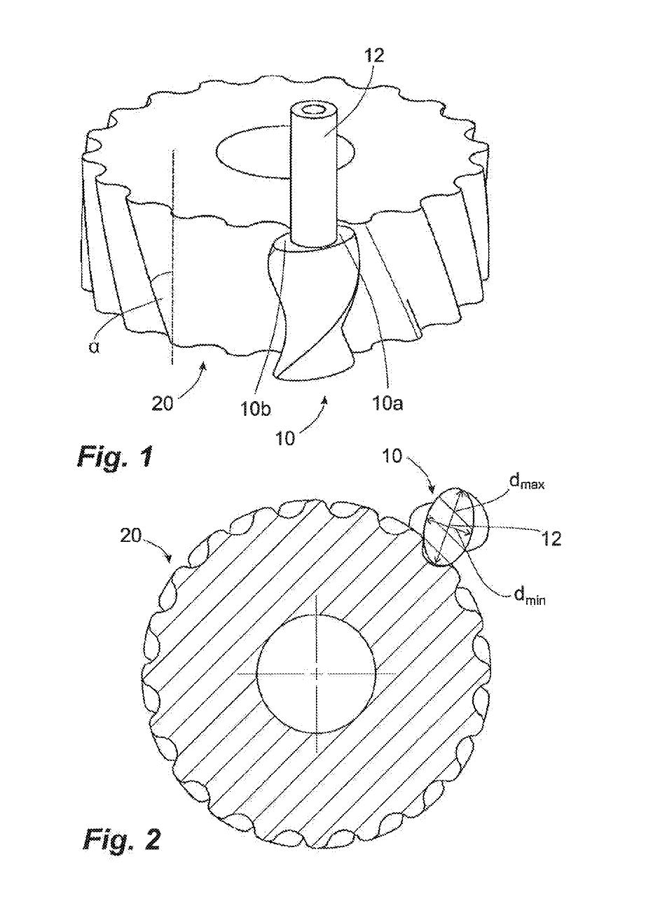

FIGS. 1 and 2 show in a perspective and a sectional top view two gear wheels 10, 20 which cog with one another. Gear wheel 10 involves the gear wheel according to the invention with only two teeth 10a, 10b. The cross-sectional surface of this gear wheel has an oval form and is penetrated in the region of its center by a gear wheel axis 12 or is orthogonally intersected in the region of its center by gear wheel axis 12. The cross-sectional surface furthermore has in the region of both teeth 10a, 10b its maximum extension dₘₐₓ through the geometric center and its minimum extension dₘᵢₙ offset in the circumferential direction with respect to the direction of maximum extension.

Smaller gear wheel 10 and larger gear wheel 20 are in each case helically geared, wherein helical angle α is approximately 30°. In the case of smaller gear wheel 10, the overlap angle of both teeth 10a, 10b is in each case 180°. This is to be understood such that these teeth extend over the extension of the gear wheel in the direction of its gear wheel axis 12 by 180° helically about gear wheel axis 12. As a result of the helical gearing of the gear wheels, in particular of smaller gear wheel 10, it is achieved that this is always in engagement with a tooth with larger gear wheel 20.

The cross-sectional surface of smaller gear wheel 10 is elliptical in a manner already known. As a result of this, concave tapering, which has hitherto been normal in the case of gear wheels with two teeth, on both sides between the teeth is omitted, as a result of which high stability of this gear wheel in particular under load is achieved. The elliptical form is not without alternatives here. For example, the cross-sectional surface could also have the form of a superellipse. The only relevant aspect is that the outer contour of the cross-sectional surface is configured to be entirely convex in order to avoid weaknesses of the gear wheel as a result of concave outer contours.

The represented gear wheel pairing is preferably used in the case of transmission of mechanical power of up to 2 kW. While smaller gear wheel 10 is preferably metallic in order to withstand a long-term loading despite its only two teeth, the use of plastic materials is preferred in the case of larger gear wheel 20.

In the case of a gear wheel pairing with only two gear wheels, as is represented in FIGS. 1 and 2, the helical gearing is obligatory.

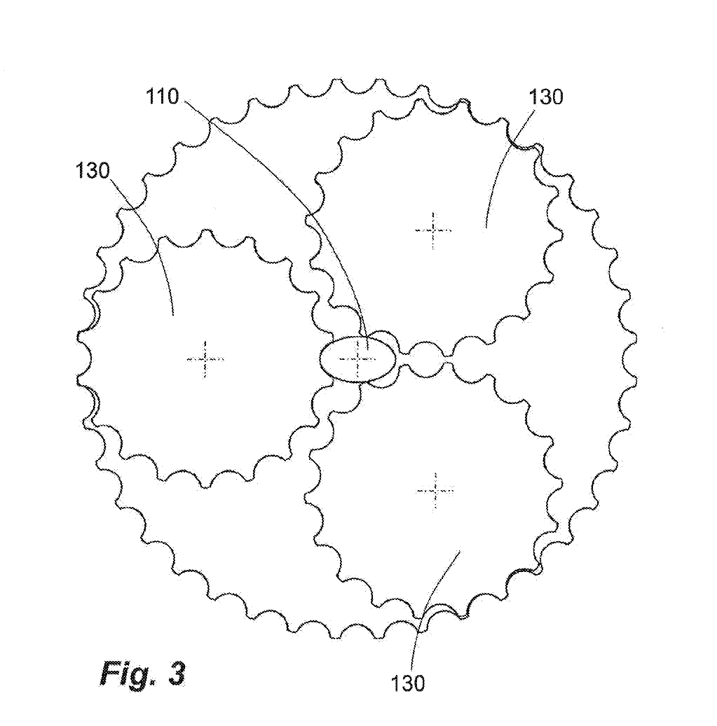

In the case of a configuration like that of FIG. 3 in which gear wheel 110 provided with only two teeth serves as a sun wheel of a planetary transmission and is therefore in engagement at least in phases with three planetary wheels 130, such a helical gearing can be omitted or the overlap angle of gear wheel 110 can be reduced.

FIG. 3 shows a configuration in which no helical gearing is provided. Gear wheel 110 thus has the shaping of a cylinder with elliptical base surface and is alternately in engagement with in each case one of the three gear wheels 130.

Instead of the gear wheel according to the invention cogging with an externally toothed gear wheel, in the case of a variant not represented, a gear wheel pairing is provided in which the gear wheel which cogs with the gear wheel according to the invention is formed as an internally toothed internal gear.

1-15. (canceled)

16. A gear wheel, comprising:
precisely two teeth, wherein
the gear wheel is mounted rotatably about a gear wheel axis,
in a sectional plane, which is arranged orthogonally to the gear wheel axis, the gear wheel has a cross-sectional surface,
the cross-sectional surface is intersected in its geometric center by the gear wheel axis,
the cross-sectional surface has in the region of both teeth its maximum extension (dₘₐₓ) through the geometric center and, offset in the circumferential direction with respect to the direction of maximum extension, has its minimum extension (dₘᵢₙ), and
the outer contour of the cross-sectional surface is formed convexly over the entire circumference.

17. The gear wheel as claimed in claim 16, wherein
the gear wheel is helically geared with an overlap angle of at least 180°.

18. The gear wheel as claimed in claim 17, wherein
the helical angle of the gear wheel is greater than 0° and is 65° or less.

19. The gear wheel as claimed in claim 18, wherein
the helical angle of the gear wheel is 15° or more and is 50° or less.

20. The gear wheel as claimed in claim 16, wherein
the maximum extension (dₘₐₓ) is between a factor of 1.25 and a factor of 2.25 greater than the minimum extension (dₘₘ).

21. The gear wheel as claimed in claim 16, wherein
the maximum extension (dₘₐₓ) of the cross-sectional surface is offset by 90° with respect to the minimum extension (dₘᵢₙ).

22. The gear wheel as claimed in claim 16, wherein
the outer contour of the cross-sectional surface has the form of an ellipse.

23. The gear wheel as claimed in claim 16, wherein
an overlap of the teeth is between greater than/equal to 180° and less than 360°.

24. A gear wheel arrangement, comprising:
at least two gear wheels in cogging engagement, wherein
a smaller or a smallest of the at least two gear wheels comprises:
precisely two teeth, wherein
the gear wheel is mounted rotatably about a gear wheel axis,
in a sectional plane, which is arranged orthogonally to the gear wheel axis, the gear wheel has a cross-sectional surface,
the cross-sectional surface is intersected in its geometric center by the gear wheel axis,
the cross-sectional surface has in the region of both teeth its maximum extension (dₘₐₓ) through the geometric center and, offset in the circumferential direction with respect to the direction of maximum extension, has its minimum extension (dₘᵢₙ), and
the outer contour of the cross-sectional surface is formed convexly over the entire circumference.

25. The gear wheel arrangement as claimed in claim 24, wherein
a larger gear wheel or larger gear wheels has/have a number of teeth of ten or more teeth.

26. The gear wheel arrangement as claimed in claim 24, wherein
at least two larger gear wheels are provided which cog in each case with the smaller gear wheel.

27. The gear wheel arrangement as claimed in claim 24, wherein
the smaller of the gear wheels is manufactured from metal and the larger of the gear wheels is manufactured from plastic.

28. The gear wheel arrangement as claim in claimed 24, wherein
the gear wheel is helically geared with an overlap angle of at least 180°.

29. The gear wheel arrangement as claimed in claim 28, wherein p1 the helical angle of the gear wheel is greater than 0° and is 65° or less.

30. The gear wheel arrangement as claimed in claim 24, wherein
the maximum extension (dₘₐₓ) is between a factor of 1.25 and a factor of 2.25 greater than the minimum extension (dₘᵢₙ).

31. The gear wheel arrangement as claimed in claim 24, wherein
the maximum extension (dₘₐₓ) of the cross-sectional surface is offset by 90° with respect to the minimum extension (dₘᵢₙ).

32. A transmission, comprising:
a gear wheel arrangement, wherein the gear wheel arrangement comprises
at least two gear wheels in cogging engagement, wherein
a smaller or a smallest of the at least two gear wheels, comprises:
precisely two teeth, wherein
the gear wheel is mounted rotatably about a gear wheel axis,
in a sectional plane, which is arranged orthogonally to the gear wheel axis, the gear wheel has a cross-sectional surface,
the cross-sectional surface is intersected in its geometric center by the gear wheel axis,
the cross-sectional surface has in the region of both teeth its maximum extension (dₘₐₓ) through the geometric center and, offset in the circumferential direction with respect to the direction of maximum extension, has its minimum extension (dₘᵢₙ), and
the outer contour of the cross-sectional surface is formed convexly over the entire circumference.

33. The transmission as claimed in claim 32,
the transmission is a planetary transmission, a sun wheel of which is formed by the smallest gear wheel.

34. The transmission as claimed in claim 32, wherein
the transmission is a bevel wheel transmission, a bevel pinion of which is formed by the smallest gear wheel.

35. The transmission as claimed in claim 32, wherein the maximum extension (dₘₐₓ) is between a factor of 1.25 and a factor of 2.25 greater than the minimum extension (dₘᵢₙ).
